(19) United States
(12) Patent Application Publication
(10) Pub. No.: US 2018/0024574 A1
(43) Pub. Date: Jan. 25, 2018

(54) WATER HEATER APPLIANCE AND A METHOD FOR OPERATING THE SAME

(71) Applicant: Haier US Appliance Solutions, Inc., Wilmington, DE (US)

(72) Inventors: Paul Goodjohn, Crestwood, KY (US); Robert Charles Beilfuss, Fisherville, KY (US)

(21) Appl. No.: 15/218,124

(22) Filed: Jul. 25, 2016

(51) Int. Cl. G05D 7/06; G05B 15/02; G05B 11/01; F24H 9/20

(52) U.S. Cl. CPC G05D 7/0635; F24H 9/2007; G05B 15/02; G05B 11/01; G05B 2219/41303

(57) ABSTRACT

A system and method of operating a water heater appliance provides an indication to a user that an excessive amount of hot water has been drawn from the hot water heater. The system includes a hot water heater, a mixing valve, a flow detector, and a controller configured for regulating the mixing valve to restrict the flow of hot water through the mixing valve when a predetermined amount of hot water has been withdrawn within a predetermined time period. By temporarily restricting the flow of hot water, a short duration of cold water will be provided to the user as an indication that an excessive amount of hot water is being used. In response, the user may reduce or terminate the use of further hot water, resulting in a reduced energy and water consumption.

### FIELD OF THE INVENTION

The present subject matter relates generally to water heater appliances and methods for operating water heater appliances to reduce excessive hot water consumption.

### BACKGROUND OF THE INVENTION

Certain water heater appliances include a tank therein. Heating elements, such as gas burners, electric resistance elements, or induction elements, heat water within the tank during operation of such water heater appliances. During operation, relatively cold water flows into the tank, and the heating elements operate to heat such water to a predetermined temperature. In particular, the heating elements generally heat water within the tank to a very high temperature. However, the volume of available hot water is generally limited to the volume of the tank.

To provide relatively large volumes of heated water from limited capacity tanks, certain water heater appliances utilize mixing valves. Such mixing valves permit hot water within the water heater's tank to be stored at relatively high temperatures. The mixing valves mix the relatively hot water with relatively cold water in order to bring the temperature of such water down to suitable and/or more usable temperatures. For example, mixing valves may adjust the ratio of hot and cold water to supply heated water suitable for showering, washing hands, etc. Moreover, by storing the water at very high temperatures and mixing with colder water before supplying to a user, large volumes of heated water may be supplied without necessitating large tanks.

However, even when utilizing mixing valves to realize a larger capacity of heated water, periods of extended heated water use can drain all of the hot water within the tank, such that the mixing valve may no longer be capable of providing heated water at the desired temperature. For example, extended shower times can deplete the hot water stored within the tank, thus preventing other plumbing fixtures or appliances from receiving heated water on demand, e.g., hot water for a washing machine cycle. Excessive usage of heated water also necessitates the use of large amounts of cold water to replenish the hot water withdrawn from the tank, and the energy required to heat the cold water in the tank back to the predetermined temperature is also proportionally increased.

Accordingly, a water heater appliance with features for reducing hot water usage to reduce energy and water consumption would be useful. More specifically, a method of operating a water heater appliance having an associated mixing valve to encourage reduced consumption of heated water during a water usage event would be particularly beneficial.

### BRIEF DESCRIPTION OF THE INVENTION

The present subject matter provides a system and method of operating a water heater appliance to provide an indication to a user that an excessive amount of hot water has been drawn from the hot water heater. The system includes a hot water heater, a mixing valve, a flow detector, and a controller configured for regulating the mixing valve to restrict the flow of hot water through the mixing valve when a predetermined amount of hot water has been withdrawn within a predetermined time period. By temporarily restricting the flow of hot water, a short duration of cold water will be provided to the user as an indication that an excessive amount of hot water is being used. In response, the user may reduce or terminate the use of further hot water, resulting in reduced energy and water consumption. Additional aspects and advantages of the invention will be set forth in part in the following description, or may be apparent from the description, or may be learned through practice of the invention.

In one exemplary embodiment, a hot water heater system is provided. The hot water heater system includes a hot water heater configured for heating cold water from a water supply and discharging hot water through a hot water outlet line. A mixing valve selectively mixes cold water from the water supply with the hot water from the hot water outlet line to provide heated water to a mixed water conduit. A flow detector is configured for measuring the amount of hot water that has been discharged through the hot water outlet line. A controller is in operative communication with the flow detector, the controller configured for regulating the mixing valve to decrease the flow of hot water through the mixing valve when a predetermined amount of hot water has been discharged through the hot water outlet line within a predetermined time interval.

In another exemplary embodiment, a method of controlling the duration of hot water usage is provided. The method includes providing cold water and hot water to a mixing valve and discharging water from the mixing valve at a selected temperature by mixing the cold water and the hot water. The method further includes detecting the amount of hot water discharged and restricting the flow of hot water through the mixing valve after a predetermined amount of hot water has been discharged within a predetermined time interval.

In yet another exemplary embodiment, a hot water heater system is provided. The hot water heater system includes a hot water tank having a heater, a cold water inlet line, and a hot water outlet line. A mixing valve is fluidly coupled to the cold water inlet line and the hot water outlet line and a mixed water conduit configured to fluidly couple the mixing valve to at least one water consuming device. A controller is operatively coupled to the mixing valve and a flow detector is operatively coupled to the hot water outlet line and the controller. The controller is operative in response to the flow detector to detect an amount of hot water discharged during a predetermined time interval and restrict the flow of hot water through the mixing valve after a predetermined amount of hot water has been discharged within the predetermined time interval.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of a water heater system including the exemplary water heater appliance of FIG. 1 according to an exemplary embodiment of the present subject matter.

FIG. 3 illustrates a method for providing an indication to a user that an excessive amount of hot water has been drawn from the exemplary water heater appliance of FIG. 1 according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

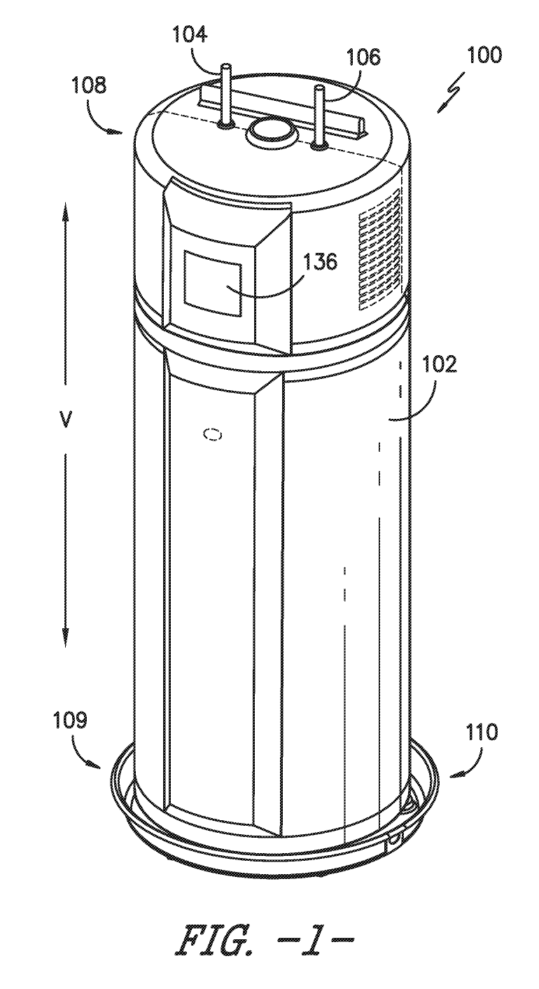

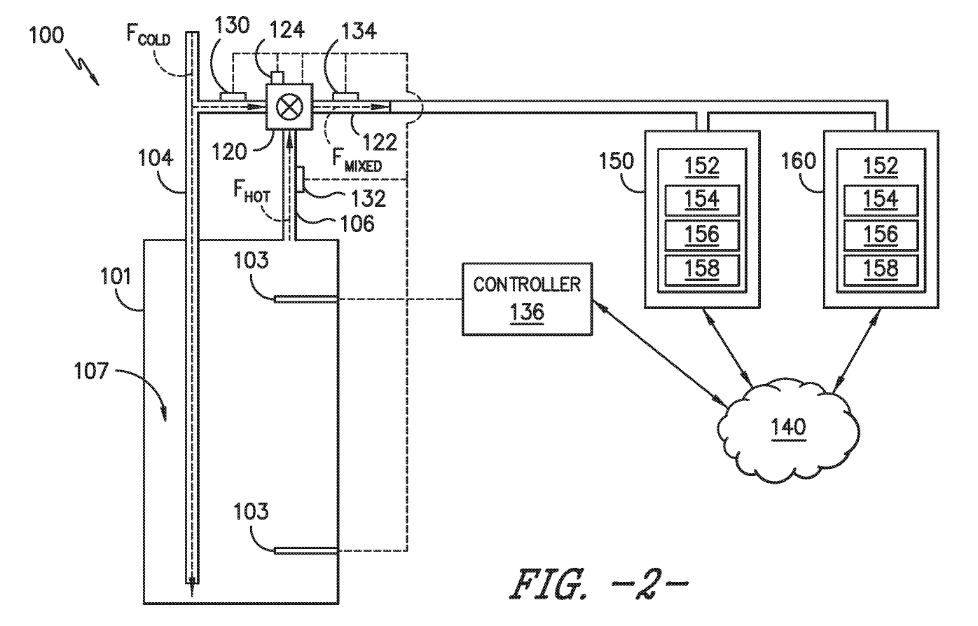

FIG. 1 provides a perspective view of a water heater appliance 100 according to an exemplary embodiment of the present subject matter. Water heater appliance 100 includes a casing 102. A tank 101 (FIG. 2) and heating elements 103 (FIG. 2) are positioned within casing 102 for heating water therein. Heating elements 103 may include a gas burner, a heat pump, an electric resistance element, a microwave element, an induction element, a sealed heat pump system or any other suitable heating element or combination thereof. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water heater appliance 100 also includes a cold water conduit 104 and a hot water conduit 106 that are both in fluid communication with a chamber 107 (FIG. 2) defined by tank 101. As an example, cold water from a water source, e.g., a municipal water supply or a well, can enter water heater appliance 100 through cold water conduit 104 (shown schematically with arrow labeled F_{cold} in FIG. 2). From cold water conduit 104, such cold water can enter chamber 107 of tank 101 wherein it is heated with heating elements 103 to generate heated water. Such heated water can exit water heater appliance 100 at hot water conduit 106 and, e.g., be supplied to a bath, shower, sink, or any other suitable feature.

Water heater appliance 100 extends longitudinally between a top portion 108 and a bottom portion 109 along a vertical direction V. Thus, water heater appliance 100 is generally vertically oriented. Water heater appliance 100 can be leveled, e.g., such that casing 102 is plumb in the vertical direction V, in order to facilitate proper operation of water heater appliance 100. A drain pan 110 is positioned at bottom portion 109 of water heater appliance 100 such that water heater appliance 100 sits on drain pan 110. Drain pan 110 sits beneath water heater appliance 100 along the vertical direction V, e.g., to collect water that leaks from water heater appliance 100 or water that condenses on an evaporator of water heater appliance 100. It should be understood that water heater appliance 100 is provided by way of example only and that the present subject matter may be used with any suitable water heater appliance.

FIG. 2 provides a schematic view of certain components of water heater appliance 100. As may be seen in FIG. 2, water heater appliance 100 includes a mixing valve 120 and a mixed water conduit 122. Mixing valve 120 is in fluid communication with cold water conduit 104, hot water conduit 106, and mixed water conduit 122. As discussed in greater detail below, mixing valve 120 is configured for selectively directing water from cold water conduit 104 and hot water conduit 106 into mixed water conduit 122 in order to regulate a temperature of water within mixed water conduit 122.

As an example, mixing valve 120 can selectively adjust between a first position and a second position. In the first position, mixing valve 120 can permit a first flow rate of relatively cool water from cold water conduit 104 (shown schematically with arrow labeled F_{cold} in FIG. 2) into mixed water conduit 122 and mixing valve 120 can also permit a first flow rate of relatively hot water from hot water conduit 106 (shown schematically with arrow labeled Fₕₒₜ in FIG. 2) into mixed water conduit 122. In such a manner, water within mixed water conduit 122 (shown schematically with arrow labeled F_{mixed} in FIG. 2) can have a first particular temperature when mixing valve 120 is in the first position. Similarly, mixing valve 120 can permit a second flow rate of relatively cool water from cold water conduit 104 into mixed water conduit 122 and mixing valve 120 can also permit a second flow rate of relatively hot water from hot water conduit 106 into mixed water conduit 122 in the second position. The first and second flow rates of the relatively cool water and relatively hot water are different such that water within mixed water conduit 122 can have a second particular temperature when mixing valve 120 is in the second position. In such a manner, mixing valve 120 can regulate the temperature of water within mixed water conduit 122 and adjust the temperature of water within mixed water conduit 122 between the first and second particular temperatures.

It should be understood that, in certain exemplary embodiments, mixing valve 120 is adjustable between more positions than the first and second positions. In particular, mixing valve 120 may be adjustable between any suitable number of positions in alternative exemplary embodiments. For example, mixing valve 120 may be infinitely adjustable in order to permit fine-tuning of the temperature of water within mixed water conduit 122.

Mixing valve 120 may be an electronic mixing valve. In addition, mixing valve 120 may be positioned within casing 102, e.g., above tank 101. Thus, mixing valve 120 may be integrated within water heater appliance 100. According to still other exemplary embodiments, mixing valve 120 may be positioned remote from water heater appliance 100, e.g., proximate a water consuming device.

Water heater appliance 100 also includes a position sensor 124. Position sensor 124 is configured for determining a position of mixing valve 120. Position sensor 124 can monitor the position of mixing valve 120 in order to assist with regulating the temperature of water within mixed water conduit 122. For example, position sensor 124 can determine when mixing valve 120 is in the first position or the second position in order to ensure that mixing valve 120 is properly or suitably positioned depending upon the temperature of water within mixed water conduit 122 desired or selected. Thus, position sensor 124 can provide feedback regarding the status or position of mixing valve 120.

According to the illustrated exemplary embodiment, water heater appliance 100 also includes a cold water conduit flow detector or first temperature sensor 130, a hot water conduit flow detector or second temperature sensor 132, and a mixed water conduit flow detector or third temperature sensor 134. First temperature sensor 130 is positioned on or proximate cold water conduit 104 and is configured for measuring a temperature of water within cold water conduit 104. First temperature sensor 130 is positioned upstream of mixing valve 120. Second temperature sensor 132 is positioned on or proximate hot water conduit 106 and is configured for measuring a temperature of water within hot water conduit 106. Second temperature sensor 132 is also positioned upstream of mixing valve 120. Third temperature sensor 134 is positioned on or proximate mixed water conduit 122 and is configured for measuring a temperature of water within mixed water conduit 122. Third temperature sensor 134 is positioned downstream of mixing valve 120. In certain exemplary embodiments, first temperature sensor 130, second temperature sensor 132, and/or third temperature sensor 134 may be positioned proximate or adjacent mixing valve 120.

Water heater appliance 100 further includes a controller 136 that is configured for regulating operation of water heater appliance 100. Controller 136 is in, e.g., operative communication with heating elements 103, mixing valve 120, position sensor 124, and temperature sensors 130, 132, and 134. Thus, controller 136 can selectively activate heating elements 103 in order to heat water within chamber 107 of tank 101. Similarly, controller 136 can selectively operate mixing valve 120 in order to adjust a position of mixing valve 120 and regulate a temperature of water within mixed water conduit 122.

Controller 136 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 136 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 136 can be positioned at a variety of locations. In the exemplary embodiment shown in FIG. 1, controller 136 is positioned within water heater appliance 100, e.g., as an integral component of water heater appliance 100. In alternative exemplary embodiments, controller 136 may positioned away from water heater appliance 100 and communicate with water heater appliance 100 over a wireless connection or any other suitable connection, such as a wired connection.

Controller 136 can operate heating elements 103 to heat water within chamber 107 of tank 101. As an example, a user can select or establish a set-point temperature for water within chamber 107 of tank 101, or the set-point temperature for water within chamber 107 of tank 101 may be a default value. Based upon the set-point temperature for water within chamber 107 of tank 101, controller 136 can selectively activate heating elements 103 in order to heat water within chamber 107 of tank 101 to the set-point temperature for water within chamber 107 of tank 101. The set-point temperature for water within chamber 107 of tank 101 can be any suitable temperature. For example, the set-point temperature for water within chamber 107 of tank 101 may be between about one hundred and forty degrees Fahrenheit and about one hundred and eighty-degrees Fahrenheit.

Controller 136 can also operate mixing valve 120 to regulate the temperature of water within mixed water conduit 122. For example, controller 136 can adjust the position of mixing valve 120 in order to regulate the temperature of water within mixed water conduit 122. As an example, a user can select or establish a predetermined temperature or a set-point temperature of mixing valve 120, or the set-point temperature of mixing valve 120 may be a default value. Based upon the set-point temperature of mixing valve 120, controller 136 can adjust the position of mixing valve 120 in order to change or tweak a ratio of relatively cool water flowing into mixed water conduit 122 from cold water conduit 104 and relatively hot water flowing into mixed water conduit 122 from hot water conduit 106. In such a manner, controller 136 can regulate the temperature of water within mixed water conduit 122.

The set-point temperature of mixing valve 120 can be any suitable temperature. For example, the set-point temperature of mixing valve 120 may be between about one hundred degrees Fahrenheit and about one hundred and twenty degrees Fahrenheit. In particular, the set-point temperature of mixing valve 120 may be selected such that the set-point temperature of mixing valve 120 is less than the set-point temperature for water within chamber 107 of tank 101. In such a manner, mixing valve 120 can utilize water from cold water conduit 104 and hot water conduit 106 to regulate the temperature of water within mixed water conduit 122.

As best illustrated in FIG. 2, according to an exemplary embodiment of the present subject matter, mixed water conduit 122 may be in fluid communication with a first water consuming device 150 and a second water consuming device 160. More specifically, water consuming devices 150, 160 may be configured to selectively draw water from mixed water conduit 122 as needed for operation. As used herein, “water consuming device” may refer to any suitable plumbing fixture, household appliance, or any other suitable device configured to draw water from water heater appliance 100. Moreover, water heater appliance 100 may be configured to supply one or more than two water consuming devices or fixtures according to alternative embodiments.

According to an exemplary embodiment, water consuming devices 150, 160 may be smart appliances that are communicatively coupled to controller 136 via a wired or wireless connection. For example, as illustrated in FIG. 2, water consuming devices 150, 160 are connected to water heater appliance 100 through a network 140. Network 140 can be any type of communication network. For example, network 140 can include one or more of a wireless network, a wired network, a personal area network, a local area network, a wide area network, the internet, etc. According to an exemplary embodiment, water consuming devices 150, 160 may communicate with water heater appliance 100 over network 140, such as the internet, to send and/or receive status information, operating information, notification, or commands from water consuming devices 150, 160, as described below.

To establish communications with network 140, each of water consuming devices 150, 160 includes, for example, a controller 152. Various components of exemplary controller 152 are illustrated in schematic fashion in FIG. 2. As shown, controller 152 may include one or more processor(s) 154 and associated memory device(s) 156 configured to perform a variety of computer-implemented functions (e.g., performing the methods, steps, and the like disclosed herein). By way of example, processor 154 may include one or more microprocessors, such as general or special purpose microprocessors operable to execute programming instructions or micro-control code associated with an operating cycle. Memory 156 may represent random access memory such as DRAM, or read only memory such as ROM or FLASH. In one embodiment, processor 154 executes programming instructions stored in memory 156. Memory 156 may be a separate component from processor 154 or may be included onboard within processor 154.

Additionally, controller 152 may also include a communications module 158 to facilitate communications between controller 152 and controller 136 of water heater appliance 100 (or other networked devices). For instance, the communications module 158 may serve as an interface to permit controller 152 to transmit and/or receive operating data related to the draw of water from mixed water conduit 122. For example, controller 152 may communicate the flow rate or temperature of the flow of water from mixed water conduit 122 or provide an override indication, as described below. According to some exemplary embodiments, communications module 158 may also include an interface (e.g., one or more analog-to-digital converters) to permit input signals to be converted into signals that can be understood and processed by the processor 154.

According to an exemplary embodiment, controller 136 may be used to determine the amount of hot water being drawn through hot water conduit 106. For example, water heater appliance 100 is described above as having three flow detectors in the form of temperature sensors 130-134. To determine the flow rate of water within mixed water conduit 122, controller 136 may receive temperature measurements from third temperature sensor 134, which correspond to the temperature of water within mixed water conduit 122. Notably, when water heater appliance 100 is not experiencing a water draw event and water is not flowing through water heater appliance 100, the temperature of water within mixed water conduit 122 may be stable or may change slowly. Therefore, if the temperature measurements are changing significantly, controller 136 may determine that hot water is being withdrawn. Thus, controller 136 may monitor the temperature measurements from third temperature sensor 134 for significant changes in order to establish if water heater appliance 100 is experiencing a water draw event and may further use an algorithm to determine the flow rate of hot water. An exemplary method of using temperature measurements for flow detection is described in U.S. application Ser. No. 14/755,279 to Ward et al., which is incorporated herein by reference in its entirety.

Therefore, controller 136 may utilize temperature measurements from third temperature sensor 134 to quickly and/or accurately determine whether water heater appliance 100 is experiencing a water draw event and the flow rate at which water is flowing through water heater appliance 100. Thus, water heater appliance 100 need not include a flow meter or other device for mechanically detecting water draw events, in certain exemplary embodiments, which can result in cost savings and improved reliability.

Although the method of flow detection described above uses temperature measurements to determine a flow rate of water, it should be appreciated that other methods of flow detection may be used while remaining within the scope of the present subject matter. For example, second temperature sensor 132 may be used or multiple temperature sensors may be used. Alternatively, instead of approximating the flow rate of water within mixed water conduit 122 by measuring its temperature drop over a period of time using third temperature sensor 134, the flow of water could be measured using any suitable flow meter. Other flow detection configurations and methods are also possible.

Now that the construction and configuration of water heater appliance 100 and water consuming devices 150, 160 according to an exemplary embodiment of the present subject matter have been presented, an exemplary method 200 for operating a water heater appliance according to an exemplary embodiment of the present subject matter is provided. Method 200 can be used to operate any suitable water heater appliance. For example, method 200 may be utilized to operate water heater appliance 100 (FIG. 1) for providing heated water to water consuming devices 150, 160. In this regard, for example, controller 136 of water heater appliance 100 may be programmed to implement method 200 and can assist with operating water heater appliance 100, e.g., by regulating mixing valve 120 in accordance with method 200. Similarly, controllers 152 may be configured for communicating with controller 136 as necessary to implement method 200.

In general, method 200 may be used to provide an indication or otherwise notify a user of a water consuming device that an excessive amount of hot water is being used. As explained below, what qualifies as “excessive” usage of hot water may be set by the manufacturer or the user, e.g., using controller 136. Hot water usage may be measured by the volume of hot water discharged, the duration of hot water discharge, etc. The indication provided to the user is typically an adjustment in the water temperature, as controlled by mixing valve 120, which may be detected by the user of the heated water. For example, when a user has exceeded the preset hot water usage level, mixing valve 120 may be regulated to provide a burst of cold water that serves as an indication to the user that they have used an excessive amount of hot water.

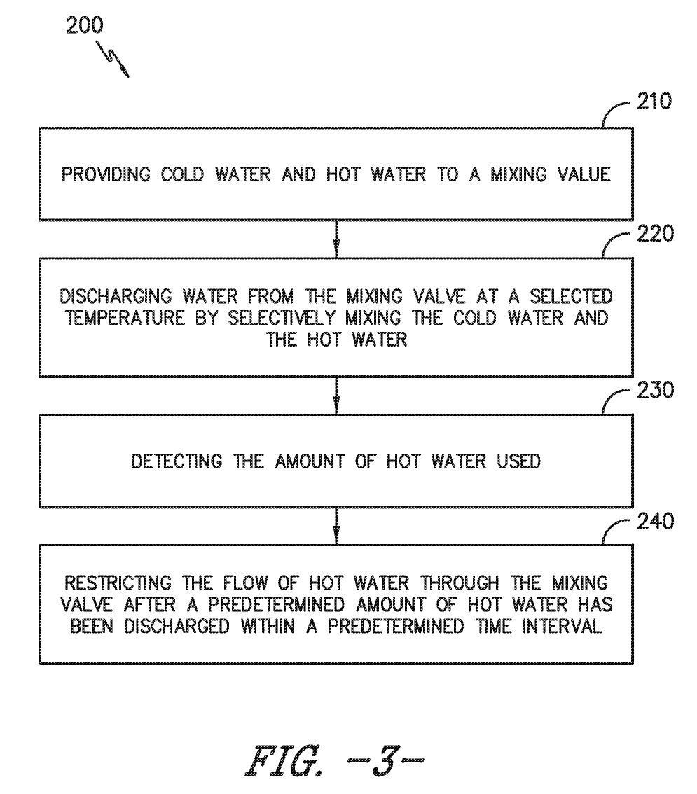

Referring now specifically to FIG. 3, method 200 includes, at step 210, providing cold water and hot water to a mixing valve. Using water heater appliance 100 as an example, cold water is first provided through cold water conduit 104 both into tank 107 and into mixing valve 120 of water heater appliance 100. As explained above, controller 136 may then operate heating elements 103 to raise the temperature of the cold water stored within tank 107 to a predetermined temperature which may, for example, be set by the user of water heater appliance 100. Once tank 107 contains hot water, water heater appliance 100 may provide that hot water to water mixing valve 120.

At step 220, water is discharged from mixing valve 120 into mixed water conduit 122 at the desired temperature by selectively mixing the cold water and the hot water. More specifically, the cold water may be supplied to mixing valve 120 through cold water conduit 104 and the hot water may be supplied to mixing valve 120 through hot water conduit 106. Mixing valve 120 may adjust the ratio of hot and cold water such that the heated water within mixed water conduit 122 matches the temperature requested by a water consuming device, such as water consuming device 150. The requested temperature of water drawn through mixed water conduit 122 and discharged to the water consuming device may be controlled by water consuming device 150, e.g., using a valve. For example, water consuming device 150 may be a shower fixture valve. When a user opens the valve and indicates a desired water temperature, mixing valve 120 mixes hot and cold water in the proportions necessary to provided heated water at the desired temperature to the fixture through mixed water conduit 122.

Method 200 further includes, at step 230, detecting the amount of hot water used. As explained above, the step of detecting the amount of hot water used may include using one or more temperature sensors to measure the temperature of the flow of hot or heated water to determine the flow rate of the hot water. For example, controller 136 may use measurements from third temperature sensor 134 to calculate the flow rate of hot water through hot water conduit 106. According to alternative embodiments, a flow meter may be used to measure the volumetric flow rate of the hot water. In this regard, for example, temperature sensors 130, 132, and/or 134 could be replaced by flow meters.

At step 240, the flow of hot water through the mixing valve is restricted after a predetermined amount of hot water has been discharged within a predetermined time interval. For example, controller 136 may monitor the draw of hot water from tank 107 as described above. If the amount of hot water drawn within a predetermined time interval exceeds some threshold set by the user or the manufacturer, the discharge of further hot water may be reduced or terminated by mixing valve 120. According to an exemplary embodiment, mixing valve 120 may be regulated such that the flow hot water is either completely stopped (i.e., mixing valve 120 is placed in a zero hot flow position) or at least substantially stopped. As used herein, “substantially stopped” is used to mean that the mixing valve 120 is regulated such that the flow of hot water is restricted to within ten percent of the zero hot flow position. In this manner, only cold water, or at least substantially colder water, is delivered to water consuming device 150 through mixed water conduit 122. The user of water consuming device 150 will feel that the water has become cold, which will serve as an indication that the user has exceeded the preset threshold of hot water usage. Although the exemplary embodiment describes providing an indication of excessive hot water usage with a cold burst of water, it should be appreciated that the indication could be any change in water temperature that is detectable by the user.

Controller 136 may be configured to allow a user or the manufacturer to set and control some or all parameters associated with the above-described method 200 of providing an indication of excess water usage. For example, a user may set the amount of time hot water may be used before the hot water is restricted, the temperature at which mixing valve 120 provides water during a hot water restriction, the duration of the hot water restriction, etc. According to some embodiments, controller 136 may be configured to receive an override indication from the user. An override indication terminates the implementation of method 200, such that water is provided to mixed water conduit 122 at the requested temperature, i.e., the flow of hot water is not restricted, even after excessive hot water usage has been detected. According to an exemplary embodiment, the override indication may be input by the user at controller 136. Alternatively, a user may be provided with a communication link, such as a control panel in the shower or an application on a cell phone, through which the user may remotely override or adjust the parameters described above, or may turn off the excess hot water usage indication feature altogether.

According to still another embodiment, controller 136 may be configured to receive an override indication from water consuming devices 150, 160. For example, when one or more of water consuming devices 150, 160 provide an override indication via network 140, controller 136 continues to provide hot water at the requested rate, i.e., the flow of hot water is not restricted, regardless of the amount of hot water used. This may be ideal for situations where it is desirable to ensure hot water is received by a connected water consuming appliance. For example, if a user is taking an extended shower when the washing machine starts, the washing machine may send a signal, e.g., via network 140 as described above, to override the impending restriction of hot water. In this manner, the wash cycle will not be adversely affected by the washing machine being supplied with cold water.

As described above, controller 136 is configured to restrict the discharge of hot water to notify a user they have used an excess amount of water. According to some embodiments, the hot water may be restricted temporarily before being resupplied to mixed water conduit 122. For example, controller 136 may be configured to regulate mixing valve 120 to provide a short, thirty or forty-five second burst of cold water after an interval of excess hot water usage has been detected, after which hot water may be resupplied through mixing valve 120. By limiting the duration of cold water supply, a user may receive an indication of excessive hot water usage without significantly disrupting the operation of other water consuming appliances. A system configured for providing only short bursts of cold water may be desirable particularly when using water consuming appliances that are not connected via network 140, such that they may not otherwise provide an override indication to controller 136. According to alternative embodiments, controller 136 may permanently shut off the hot water until, e.g., the user resets the mixing valve 120 using controller 136, shuts off the water at water consuming device 150, or performs some other action.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A hot water heater system comprising:
a hot water heater configured for heating cold water from a water supply and discharging hot water through a hot water outlet line;
a mixing valve for selectively mixing cold water from the water supply with the hot water from the hot water outlet line to provide heated water to a mixed water conduit;
a flow detector configured for measuring the amount of hot water that has been discharged through the hot water outlet line; and
a controller in operative communication with the flow detector, the controller configured for regulating the mixing valve to decrease the flow of hot water through the mixing valve when a predetermined amount of hot water has been discharged through the hot water outlet line within a predetermined time interval.

2. The hot water heater system of claim 1, wherein the flow detector is operably coupled to the hot water outlet line or the mixed water conduit.

3. The hot water heater system of claim 1, wherein the flow detector is a flow meter configured to measure the volumetric flow rate of the hot water.

4. The hot water heater system of claim 1, wherein the flow detector is one or more temperature sensors, wherein the flow rate of the hot water is determined from a temperature drop of the hot water flowing through the hot water outlet line.

5. The hot water heater system of claim 1, wherein the mixing valve is positioned proximate the hot water heater.

6. The hot water heater system of claim 1, wherein restricting the flow of hot water through the mixing valve comprises substantially stopping the flow of hot water through the mixing valve such that substantially cold water passes through the mixed water conduit for a predetermined notification interval.

7. The hot water heater system of claim 1, wherein the hot water heater is in fluid communication with one or more water consuming devices through the mixed water conduit, each of the one or more water consuming devices being in operative communication with the controller.

8. The hot water heater system of claim 7, wherein at least one of the one or more water consuming devices are in wireless communication with the controller.

9. A method of controlling the duration of hot water usage, the method comprising:
providing cold water and hot water to a mixing valve;
discharging water from the mixing valve at a selected temperature by mixing the cold water and the hot water;
detecting the amount of hot water discharged; and
restricting the flow of hot water through the mixing valve after a predetermined amount of hot water has been discharged within a predetermined time interval.

10. The method of claim 9, wherein the step of detecting the amount of hot water discharged comprises using a flow meter configured to measure the volumetric flow rate of the hot water.

11. The method of claim 9, wherein the step of detecting the amount of hot water discharged comprises using one or more temperature sensors to measure the temperature of the flow of hot water to determine the flow rate of the hot water.

12. The method of claim 9, wherein the step of restricting the flow of hot water through the mixing valve comprises substantially stopping the flow of hot water through the mixing valve such that substantially cold water is discharged from the mixing valve for a predetermined notification interval.

13. The method of claim 9, wherein the mixing valve is in fluid communication with one or more water consuming devices, the method further comprising:
receiving an override indication from one of the one or more water consuming devices such that the flow of hot water is not restricted after the predetermined amount of hot water has been discharged within the predetermined time interval.

14. A hot water heater system comprising:
a hot water tank having a heater, a cold water inlet line, and a hot water outlet line;
a mixing valve fluidly coupled to the cold water inlet line and the hot water outlet line;
a mixed water conduit configured to fluidly couple the mixing valve to at least one water consuming device;
a controller operatively coupled to the mixing valve; and
a flow detector operatively coupled to the hot water outlet line and the controller, the controller being operative in response to the flow detector to:
detect an amount of hot water discharged during a predetermined time interval; and
restrict the flow of hot water through the mixing valve after a predetermined amount of hot water has been discharged within the predetermined time interval.

15. The hot water heater system of claim 15, wherein the flow detector is a flow meter configured to measure the volumetric flow rate of the hot water.

16. The hot water heater system of claim 15, wherein the flow detector is one or more temperature sensors, wherein the flow rate of the hot water is determined from the temperature drop of the hot water flowing through the hot water outlet line.

17. The hot water heater system of claim 15, wherein restricting the flow of hot water through the mixing valve comprises substantially stopping the flow of hot water through the mixing valve such that substantially cold water passes through the mixed water conduit for a predetermined notification interval.

18. The hot water heater system of claim 15, wherein the mixed water conduit is in fluid communication with one or more water consuming devices, each of the one or more water consuming devices being in operative communication with the controller.

19. The hot water heater system of claim 18, wherein at least one of the one or more water consuming devices are in wireless communication with the controller.

20. The hot water heater system of claim 15, wherein the controller is configured to receive an override indication from at least one of the one or more water consuming devices such that the flow of hot water is not restricted after the predetermined amount of hot water has been discharged within the predetermined time interval.
